(19) United States
(12) Patent Application Publication
(10) Pub. No.: US 2013/0193740 A1
(43) Pub. Date: Aug. 1, 2013

(54) LINEAR SEAT BELT PRETENSIONER

(71) Applicants: Dario Brisighella, North Logan, UT (US); Christopher Fischer, Layton, UT (US); Brent Parks, Englewood, CO (US)

(72) Inventors: Dario Brisighella, North Logan, UT (US); Christopher Fischer, Layton, UT (US); Brent Parks, Englewood, CO (US)

(73) Assignee: AUTOLIV ASP, Inc., Ogden, UT (US)

(21) Appl. No.: 13/361,185

(22) Filed: Jan. 30, 2012

(51) Int. Cl. B60R 22/195

(52) U.S. Cl. 297/480

(57) ABSTRACT

A linear seat belt pretensioner includes a housing with a sealed axial cavity and a piston (52, 152, 232, 352, 452) slidable in the cavity. A gas generator (76, 166, 156, 376, 476) deploys into the axial cavity, thereby propelling the piston outward. Because the axial cavity is well sealed, the arrangement retains the gas pressure upon deployment and is capable of a restart after a partial displacement if additional slack develops. The piston travels by a distance (X) corresponding to the piston travel and shortens the length of seat belt webbing available outside the pretensioner device by twice or thrice the distance (2X). The axial cavity can be sealed with a bladder element, such as a rolling sock (38). Alternatively, the seal may be established by a hollow piston (152) forming a ballistic seal with the wall of the cavity under pressure.

### FIELD OF THE INVENTION

The present invention relates generally to seat belt restraint systems for motor vehicles, and more particularly, to a linear seat belt pretensioner for a seat belt restraint system.

### BACKGROUND OF THE INVENTION

Seat belt restraint systems for restraining an occupant in a vehicle seat play an important role in reducing occupant injury in vehicle crash situations. Seat belt restraint systems of the conventional so-called “3-point” variety commonly have a lap belt section extending across the seat occupant's pelvis and a shoulder belt section crossing the upper torso, which are fastened together or are formed by a continuous length of seat belt webbing. The lap and shoulder belt sections are connected to the vehicle structure by anchorages. A belt retractor is typically provided to store belt webbing and may further act to manage belt tension loads in a crash situation.

Seat belt restraint systems which are manually deployed by the occupant (so-called “active” types) also typically include a buckle attached to the vehicle body structure by an anchorage. A latch plate attached to the belt webbing is received by the buckle to allow the belt system to be fastened for enabling restraint, and unfastened to allow entrance and egress from the vehicle. Seat belt systems, when deployed, effectively restrain the occupant during a collision.

Some seat belt restraint systems include pretensioning devices, which tension the seat belt either prior to impact of the vehicle (also known as a “pre-pretensioner”) or at an early stage of a sensed or impending impact to enhance occupant restraint performance. The pretensioner takes out slack in the webbing and permits the belt restraint system to couple with the occupant early in the crash sequence. Upon the detection of a condition leading to an imminent impact or rollover, or in the event of an actual rollover, seat belt webbing is automatically and forcibly retracted by the pretensioner to tighten the seat belt against the occupant.

One type of pretensioning device is a pyrotechnic linear pretensioner (PLP), which can be implemented as a pyrotechnic buckle pretensioner (PBP) that is attached to a seat belt buckle. PLPs can also be attached to a webbing guide loop or seat belt anchorage. Since both types pull a seat belt system component linearly to apply tension in the belt webbing, both PLPs and PBPs can be collectively referred to as PLPs. Examples of designs of PLPs and PBPs are provided by U.S. Pat. Nos. 6,068,664 and 7,823,924, which are hereby incorporated by reference. Typical PLPs have a pyrotechnic charge that is fired when a collision occurs, producing expanding gas which pressurizes a gas chamber within a tube, which forces a piston down the tube. The piston is connected with the belt system by a cable or strap. Stroking of the piston tightens or “pretensions” the belt against the occupant.

One design challenge with current pretensioners utilizing gas generators is that the pretensioner is only capable of pretensioning the seat belt once. If a seat occupant is leaning forward, away from a seat back, while the gas generator is triggered, the seat belt will only eliminate slack up to the occupant's position. Once the occupant moves back toward the seat back, the seat belt will exhibit additional slack. Other situations in which the seat belt will develop additional slack occur, for example, when the seat belt webbing stretches under stress or when a seat occupant already leaning against the seat back sinks deeper into the seat back cushion, possibly due to a deployment of an airbag.

Typically, a significant volume of the gas produced by the gas generator leaks out of the device. Leak paths allow gas to leak from the device, decreasing the pressure available for pretensioning the seat belt and leading to a rapid pressure decrease. Due to this blow-by effect, manufacturers have been forced to use larger gas generators to compensate for the loss of gas. Furthermore, the gas escaping from the device into the vehicle passenger compartment may contain combustion products that may negatively affect seat occupants.

### SUMMARY OF THE INVENTION

It is an object of the present invention to reduce leak paths in a PLP. It is a further object of the present invention to provide a PLP that is capable of retensioning the seat belt if it develops slack after activating the PLP. It is yet another goal to provide a simplified, reliable, cost-effective PLP with fewer parts than what is known from the prior art.

The present invention provides a PLP that substantially reduces leak paths for gas to escape from the PLP device by providing a sealed combustion chamber. The present invention also reduces the bulk of the assembly and the stroke distance needed for the piston, while maintaining an adequate belt take-up capability.

A first embodiment of the present invention provides a pretensioner with a combustion chamber bounded by a bladder element that may be shaped as a rolling sock, allowing a gas generated to expand into a volume sealed by the bladder or rolling sock, but does not require a piston with a circumferential seal making sliding contact. The expanding bladder or rolling sock may directly act on the seat belt webbing or displace a piston that abuts the webbing or a cable connected with the restraint system.

A further embodiment provides a ballistically sealed combustion chamber that may include a hollow piston having a gas seal that is pressure activated to press against the chamber walls by the inflation gas pressure.

Additional details and advantages of the present invention become apparent to those skilled in the art of the present invention from the following description and the appended claims, in connection with the accompanying drawings of exemplary embodiments. It should be understood that the description and specific examples are intended for purposes of illustration only and are not intended to limit the scope of this invention.

### BRIEF DESCRIPTION OF THE DRAWINGS

In the drawings,

FIG. 1 shows a cross-section of a PLP according to a first embodiment of the present invention;

FIG. 2 shows a perspective view of a steel rolling sock as used in the PLP of FIG. 1 in a normal state before an actuation of the PLP;

FIG. 3 shows a cross-section of the steel rolling sock of FIG. 2 in the process of expanding;

FIG. 4 shows a second embodiment of a PLP according to the present invention with a ballistic cylinder-piston arrangement;

FIG. 5 shows a variation of the PLP of FIG. 4 at different stages of deployment in FIGS. 5a, 5b, and 5c;

FIG. 6 shows the interior arrangement of a third embodiment of a PLP according to the present invention with an alternative locking function;

FIG. 7 shows a detail of the PLP of FIG. 6;

FIG. 8 shows an alternative detail for the PLP of FIG. 6 at different stages of deployment;

FIG. 9 shows an alternative piston shape for the PLP of FIG. 6;

FIG. 10 shows another alternative piston shape for the PLP of FIG. 6;

FIG. 11 shows yet another alternative piston shape for the PLP of FIG. 6;

FIG. 12 shows a fourth embodiment of a PLP configured as a triple-stroke micro-PLP according to the present invention;

FIG. 13 shows the interior arrangement of the micro-PLP of FIG. 12;

FIG. 14 shows an exploded view of the micro-PLP of FIGS. 12 and 13;

FIG. 15 illustrates the function of the micro-PLP of FIGS. 12-14;

FIG. 16 shows a detail of the micro-PLP of FIGS. 12-15;

FIG. 17 shows an exploded view of a fifth embodiment of a PLP configured as a triple-stroke micro-PLP according to the present invention; and

FIG. 18 illustrates the function of the micro-PLP of FIG. 17.

### DETAILED DESCRIPTION OF THE DRAWINGS

The following description of various embodiments of the invention is merely exemplary in nature and is not intended to limit the present disclosure or its application or uses.

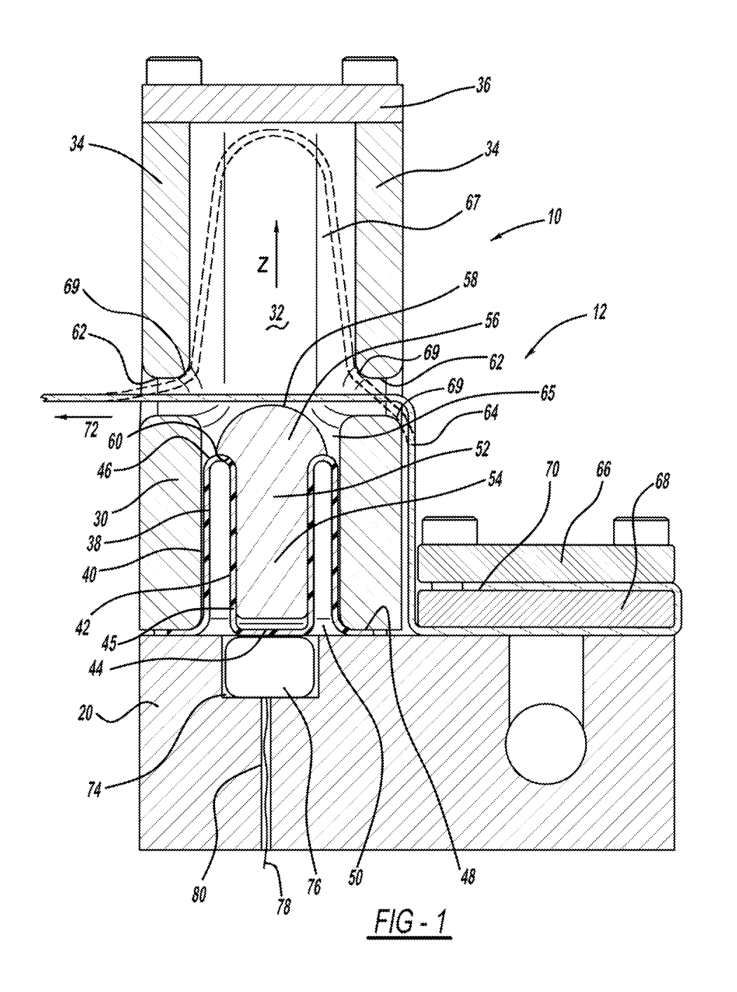

FIG. 1 shows a schematic concept of a linear pretensioner, generally designated by reference number 10, in accordance with the present invention. The pretensioner device 10 includes a housing 12 with a base block 20 anchored in a vehicle and an attached enclosure 30. The enclosure 30 accommodates an elongated cavity 32 extending along an actuation axis Z. The enclosure 30 has walls 34 extending parallel to the actuation axis Z. In the shown embodiment, the cavity 32 is closed with a lid 36 fastened to the walls 34. Alternatively, the lid 36 can be manufactured integrally in one piece with the walls 34.

Near the attachment of the enclosure 30 to the base 20, the cavity 32 accommodates a steel rolling sock 38 preferably made of a metal material such as steel. The rolling sock 38 of FIG. 1 is made of one piece of resilient sheet metal with an outer wall 40 and an inner wall 42 extending inside the outer wall 40. The inner wall 42 and a bottom 44 facing the base 20 form a pot-shaped structure 45 which, in a rim area, ends in a connecting area 46 that forms a radially outward bend that smoothly transitions into the outer wall 40. The outer wall 40 extends axially from the connecting area 46 to the base 20 and ends in a fastening flange 48.

The fastening flange 48 is secured between the base 20 and the enclosure 30, providing an airtight seal of a combustion chamber 50 arranged in an expansion space 65 and bounded by the base 20 and the rolling sock 38. The inner wall 42 and the outer wall 40 extend substantially parallel to each other. The inner and outer walls 40 and 42 may also be arranged at an angle with respect to each other so that they do not extend precisely in an axial direction. For instance, the outer wall 40 may have a tapered or an expanding diameter toward the base 20, and the inner wall 42 may have a tapered diameter toward the base block without impairing the proper functioning of the rolling sock 38.

A piston 52 with a mushroom-like cross-section has a shaft 54 adapted to fit in the pot-shaped structure 45 of the rolling sock 38. The piston 52 protrudes from the pot-shaped structure 45 with an actuating profile 56 that has a greater width than the shaft 54. The actuating profile 56 is formed by a rounded face portion 58 and an abutment shoulder 60.

Near the axial position of the face portion 58, the enclosure has two slots 62 in the walls 34 opposite each other. The slots 62 extend into the image plane of FIG. 1, perpendicular to the actuation axis Z, and have a width that is large enough to accommodate the width of a seat belt webbing 64. The seat belt webbing 64 is threaded through both slots 62 across the face 58 of the actuating profile 56, thereby dividing the cavity 32 into the expansion space 65 accommodating the piston 52 and the rolling sock 38, and a displacement space 67. The slots 62 have radii 69 at least in locations that come into contact with the seat belt webbing. This measure reduces friction and wear on the seat belt webbing 64.

At one end, the seat belt webbing 64 is securely fastened to the base 20 by attachment plates 66 and 68. The seat belt webbing 64 extends between attachment plate 68 and the base 20 all across attachment plate 68 and is folded back to continue between attachment plates 68 and 66. The end 70 of the seat belt webbing 64 is located between the two attachment plates 66 and 68. The attachment plates 66 and 68 are bolted to the base 20 through the seat belt webbing 64, thereby securing the end 70 of the seat belt webbing 64. On the side remote from the attachment plates 66 and 68, the seat belt webbing 64 leads away from the enclosure 30, where its other end 72 is connected to a latch plate or to a seat belt buckle adapted to receive a latch plate attached to a seat belt strap (not shown).

Between the slots 62, the belt webbing 64 extends freely through the housing 12 in a straight line. In an alternative application eliminating the attachment plates 66 and 68, the pretensioner device 10 can be mounted in nearly any location along the path of a seat belt because the belt webbing 64 can pass through the housing 12 with very little friction.

The base 20 comprises a recess 74 adapted to receive a gas generator 76. The gas generator 76 is a pyrotechnical device triggered by an electrical signal supplied by an electrical line 78. The electrical lines run through a channel 80 in the base 20 connecting the gas generator 76 to an external electronic control unit (not shown). An appropriate sealing material seals off the channel 80, thereby providing an airtight seal of the recess 74 toward the atmosphere.

It should be noted that the device 10 as illustrated in FIG. 1 is not a production unit. For implementing the shown concept in a production vehicle, solid blocks of material as used for the housing 10 would be replaced with formed sheet metal or other material that is less voluminous and lighter in weight.

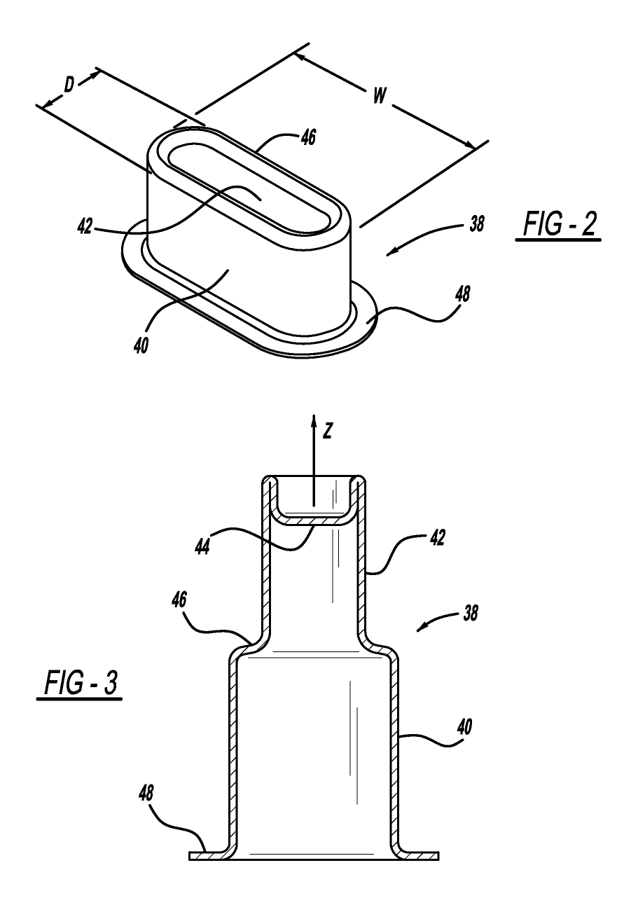

Referring now to FIG. 2, the rolling sock 38 is shown in a perspective view. It is evident that the arrangement of FIG. 1 achieves a space-saving architecture by flattening the rolling sock 38 and accordingly the piston 52. The rolling sock 38 of the shown embodiment has a width W that is approximately determined by the width of the seat belt webbing 64. The width W is dimensioned to extend over a substantial portion of the width of the seat belt webbing 64 in a horizontal direction perpendicular to the direction in which the seat belt webbing is threaded through the slots 62. This direction of the width W is typically in the same direction as a longitudinal vehicle axis. Because vehicle packaging space can be well utilized with a flattened configuration PLP, the width W of the rolling sock 38 and the corresponding width of the piston can be optimized for functional properties like secure support of the seat belt webbing, reliable pretensioning, and reaction speed.

The rolling sock 38 has a depth D that is significantly reduced compared to the width W. In the embodiment shown, the width W designating the outer dimension of the outer wall 40 usually extends in the longitudinal vehicle direction and amounts to more than double the depth D designating the outer dimension of the outer wall 40 in a transverse vehicle direction. This reduced diameter in the transverse vehicle direction allows an easy accommodation of the pretensioner in a vehicle without interfering with vehicle seats. Alternatively, the rolling sock may have an approximately cylindrical shape with a diameter corresponding to the depth D, where the piston has a T-like contour with a cylindrical shaft and a cross-bar forming the actuating profile.

Now referring to FIG. 1 again, the shown pretensioner device 10 functions in the following way. During normal operation of a vehicle equipped with the pretensioner device 10, all parts are in the positions shown and retain their positions until the pretensioner device 10 is activated. An activation occurs through an electric signal supplied via the electrical line 78, triggering the gas generator 76. Upon activation, the gas generator 76 pressurizes the combustion chamber 50, which causes the combustion chamber 50 to expand and to deform the rolling sock 38 toward the displacement space 67. As the bottom 44 of the rolling sock moves away from the base 20, it pushes piston 52 out of the expansion space 65 toward the displacement space 67. In this process, the inner wall 42 rolls toward the outside and progresses to face outward as illustrated in FIG. 3. Accordingly, the pretensioner device 10 accomplishes the displacement of the piston 52 without sliding contact seals.

The face 58 of the actuating profile of the piston 52 abuts the belt webbing 64 and pushes it into the displacement space 67 as indicated by broken lines in FIG. 1. Because the belt webbing extends along both sides of the piston 52 and wraps around the actuating profile 56, a displacement of the piston 52 reduces slack in the belt webbing 64 by approximately twice the distance of the piston displacement. The amount of reduced slack would be exactly double the piston displacement if the belt webbing extended along the piston 54 precisely in the direction Z and if the actuating profile 56 had a flat face 58. This amount of reduced slack is slightly shortened due to the angle at which the belt webbing extends from the slots 62 to the actuating profile 54 and due to the rounded face 58 of the actuating profile 56.

The gas pressure in the combustion chamber 50 is sufficient to reduce or eliminate slack in the belt webbing 64. The gas generator 76 may be dimensioned to generate a gas pressure producing a force on the piston 52 that is capable of pulling a seat occupant back into contact with a seat back or merely capable of tensioning the belt webbing 64 to a degree that slack is removed.

When the belt webbing 64 incurs a resistance force greater than approximately half of the axial force on piston 52 generated by the expanding gas in the combustion chamber 50, the piston 52 stops. Because the travel of the belt webbing 64 is approximately twice the travel of the piston 52, a seat occupant only needs to apply a tension force on the webbing end 72 amounting to approximately half of the piston force to stop the piston 52 from moving further into the displacement space 67. Depending on the dimensions of the displacement space 67, the maximum attainable piston travel is reached either when the belt webbing 64 contacts the lid 36 of the displacement space 67, or when the entire inner wall 42 of the rolling sock 38 faces outward.

Notably, the combustion chamber 50 is well sealed against gas leakage because the pretensioner device 10 does not contain any sliding contact seals to prevent gas leakage. If the piston 52 is stopped from traveling into the displacement space 67 before it has reached its maximum attainable piston travel, the combustion chamber 50 substantially retains the prevailing gas pressure. Accordingly, in the event that the seat belt webbing 64 develops additional slack due to a movement of the seat occupant or due to stretching in the belt webbing, or for other reasons, the gas pressure in the combustion chamber 50 further expands the rolling sock 38. The rolling sock 38 thus moves the piston 52 further into the displacement space 67, thereby retensioning the seat belt webbing 64. This operation is referred to as a “restart” capability.

It should be understood that the placement of the gas generator 76 is not limited to the configuration described above. For example, the gas generator 76 could be installed externally or otherwise attached to the base plate 22. The gas generator 76 is preferably a small component that fits inside the recess 74. Also, the shapes of the rolling sock 38 and the piston 52 are not limited to the embodiment shown for a proper function. The rolling sock 38 may alternatively be an accordion bellows or a bladder that may have any design suitable for expanding its axial dimension upon pressure build-up in the combustion chamber 50.

Furthermore, the shown enclosure 30 may be simplified for series production by manufacturing it from sheet metal or sturdy plastic with a wall thickness lesser than the one shown. Likewise, while the attachment plates 66 and 68 are arranged horizontally in the shown embodiment, they can be arranged vertically or may be replaced with other suitable ways of securing the end 70 of the belt webbing 64.

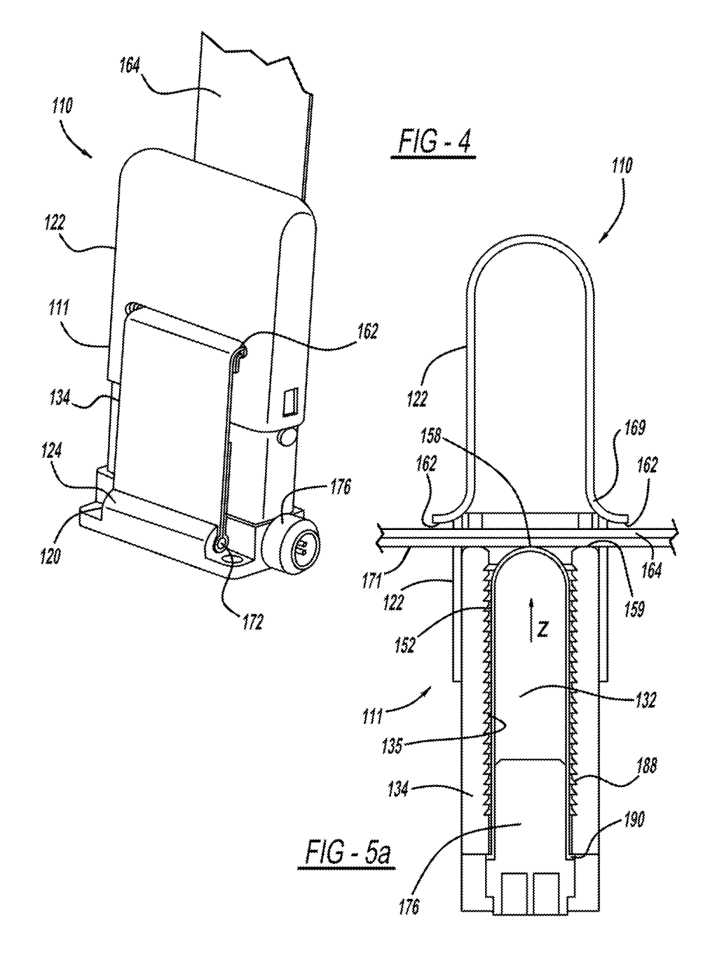

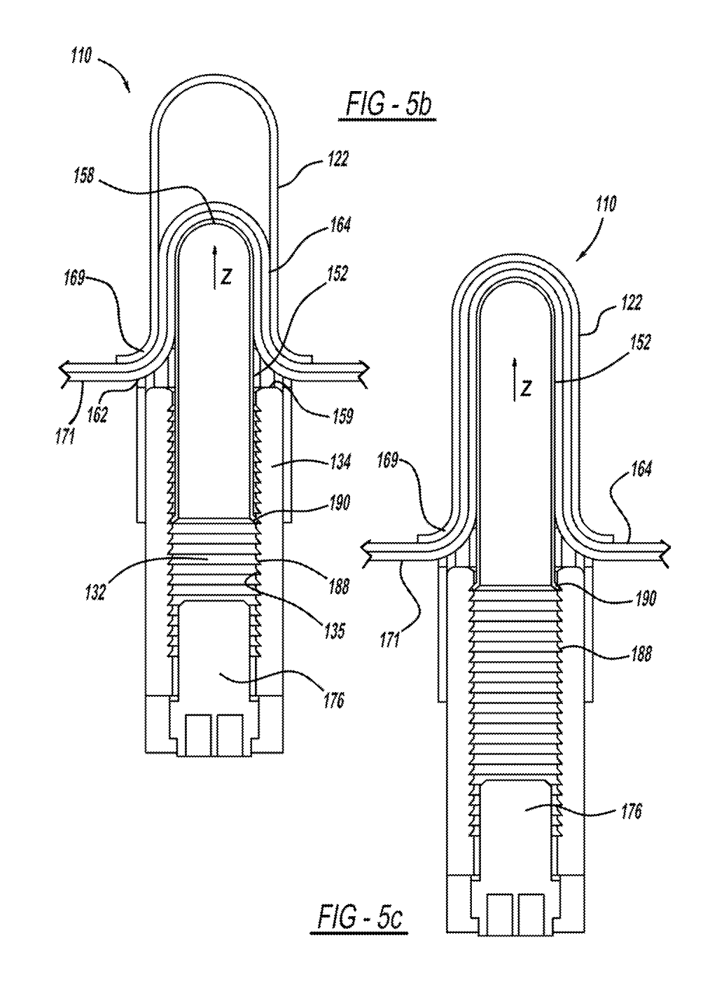

FIGS. 4 and 5 show a second embodiment of a pretensioner device 110 according to the present invention. Referring to FIG. 4, the pretensioner device 110 has a housing 111 comprising a base 120, a wall 134, and a cover 122. The base 120 is configured to be anchored in a vehicle and has a fastening structure 124 holding an end 172 of a seat belt webbing 164. From the fastening structure 124, the webbing 164 extends along the wall 134 and a portion of the cover 122 to enter into the housing 111 through a slot 162 in the cover 122. The webbing 164 exits the housing 111 on the opposite side of the slot 162 through a second slot (not visible) in the cover 122. From there, the webbing 164 extends to a seat belt buckle or latch plate (not shown).

The cover 122 has radii 169 bordering the slots 162. The radii 169 are formed by flared portions of the cover 122 and reduce wear on the webbing 164 by eliminating sharp edges. Furthermore, the belt webbing 164 of the shown embodiment has a heat barrier 171 lining the webbing 164 to prevent heat damage to the belt webbing 164. This reinforcement layer 171 extends at least over a length of the webbing 164 that is potentially exposed to the face 158 of the piston 152 during activation of the pretensioner device 110.

FIGS. 5a through 5c depict the interior components of a pretensioner device 110 with the working principles of FIG. 4. FIG. 5 also shows different stages of deployment in successive steps in FIGS. 5a through 5c. The embodiment of FIGS. 5a through 5c omits the fastening structure 124 of FIG. 4 and can be installed at any location of the seat belt webbing 164. Accordingly, the embodiment of FIGS. 5a through 5c shows slightly different shapes of individual parts compared to FIG. 4. The function, however, is analogous to that of the pretensioner 110 shown in FIG. 4.

The base 120 holds a gas generator 176 in an orientation configured to expel an expanding gas into a cavity 132 inside the surrounding wall 134. The wall 134 is provided with ratchet ribs 188 along its interior surface 135 lining the cavity 132. A hollow piston 152 is slidably guided inside the cavity 132. The piston 152 is open toward the gas generator 176 and accommodates a portion of the gas generator 176 inside the piston 152 while the piston is in a normal state as shown in FIG. 5a. The piston 152 further has a closed end with a rounded face 158 at the piston end opposite the gas generator 176.

At its open end proximate the gas generator 176, the piston 152 features a plurality of integrally formed tabs 190 bent outward and dimensioned to snap into the ratchet ribs 188 of the interior surface 135. The piston 152 may, for instance, be a stamped sheet metal part. The tabs 190 of piston 152 extend past the wall 134 into an area surrounded by the base 120. It is apparent that the ratchet ribs 188 do not have to extend around the entire circumference of the cavity 132. It is sufficient to provide a ratcheted surface in those angular areas where the tabs 190 are arranged.

The cover 122 has a rounded end portion adapted to the shape of the piston face 158, albeit with a larger diameter calculated to accommodate the belt webbing 164. The pretensioner device 110 has a normal default state shown in FIG. 5a. The piston 152 is in a retracted position and terminates with the face 158 at a location approximately flush with edge 159 of wall 134. The webbing 164 is threaded through slots 162 in the cover 122 and extends straight through the housing 111.

The webbing 164 is shown as being lined by heat barrier 171. Such a heat barrier is optional. The heat barrier 171 may extend along such a portion of the webbing 164 that may come in contact with the pretensioner device 110 or with the face 158 of the piston 152.

Once the gas generator 176 is deployed, it expels inflation gas into the cavity 132. Because the piston 152 is hollow, it expands slightly radially outward to be pressed against the interior surface 135 and to provide a pressure-actuated ballistic seal of the cavity 132.

The pressure built up by the inflation gas causes the piston 152 to move outward as shown in FIG. 5b. The piston 152 is moved away from the gas generator, partially protruding into the cover 122. The tabs 190 formed on the piston 152 are snapped into one of the ratchet ribs 188 lining the interior surface 135 of wall 134. The face 158 of the piston 152 has been displaced from the edge 159 of the wall 134 by approximately half of a piston length.

The cover 122, shaped to complement the contour of the piston 152, forces the webbing 164 to move with the piston closely aligned with the piston contour. This arrangement pulls the webbing 164 through the slots 162 into the cover 122. Accordingly any slack present in the seat belt webbing 164 outside the pretensioner device 110 is reduced by twice the distance of the piston travel.

Because the tabs 190 engage one of the ratchet ribs 188, the piston 152 is prevented from returning into the retracted normal position shown in FIG. 5a. The pressure built up by the gas generator 176 is retained in cavity 132 because the pressure expands the hollow piston 152 to establish a pressure-actuated ballistic seal between the piston 152 and the interior surface 135. The piston has not reached the end of the cover or a stop that may be placed at the edge 159 of wall 134. Therefore, the pretensioner device 110 has the restart capability described above to retighten the webbing 164 if the webbing 164 outside the pretensioner device 110 develops additional slack.

FIG. 5c shows the pretensioner device 110 after the piston 152 has traveled the farthest distance possible and has reached the end of cover 122. The piston may attain this position from the normal position of FIG. 5a with one stroke upon deployment of the gas generator 176 or in successive steps when the webbing develops slack in incremental steps.

The webbing 164 extends between the complementary shapes of the piston 152 and the cover 122. Because the webbing extends to both sides of the piston 152, the slack of the webbing 164 outside the pretensioner device 110 has been reduced by a distance amounting to approximately twice the piston travel. The tabs 190 are snapped into the uppermost one of the ratchet ribs 188 and thus hold the piston 152 in place.

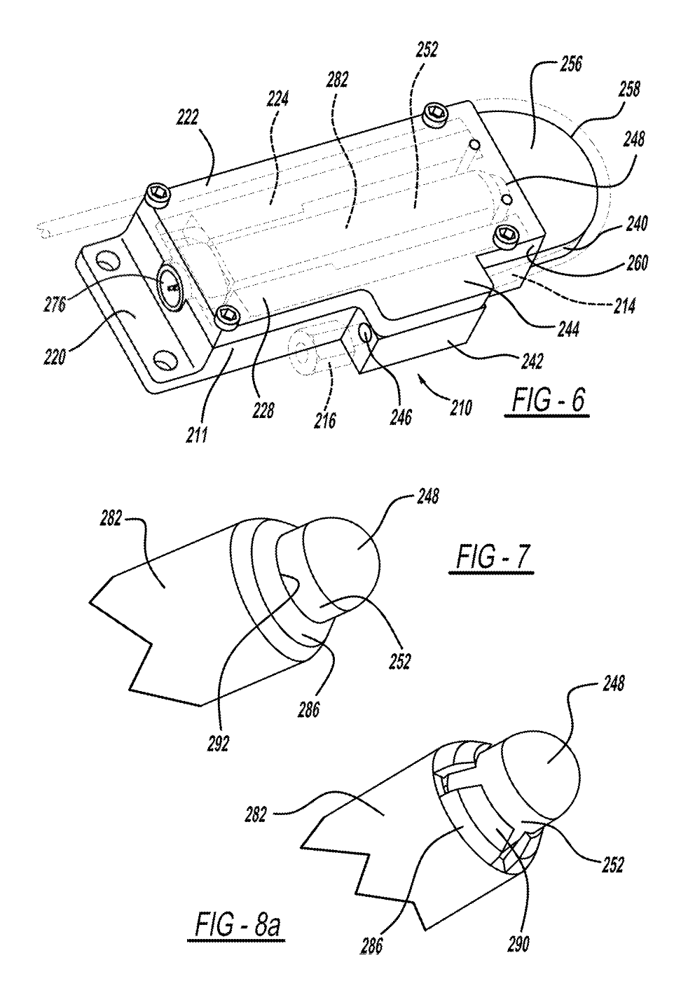

FIGS. 6 through 11 deal with several variations of a third illustrative embodiment of a pretensioner device 210 of the PLP type. This third embodiment tightens not the belt webbing itself, but a cable 214 attached to the belt webbing or to a belt buckle.

The pretensioner device 210 shown in FIG. 6 has housing 211 with a base 220 and a cover 222. The base 220 has an indentation adapted to receive guiding portions 228 of a slide 224. The guiding portions 224 extend along an axial direction and terminate in an actuating profile 256 having a face 258 with a rounded contour and abutment shoulders 260 supported by the base 220. The face 258 has a groove-like indentation 240 extending along its contour. After an installation in a vehicle, the groove receives a flexible cable 214 coupled to a seat belt webbing or to a belt buckle. For fastening the cable 214, projections 242 and 244 are formed on the base 220 and the cover 222, respectively. The projection 242 formed on the base 220 has a recess 246 for guiding the cable 214. At the side of the projections 242 and 244 remote from the face 258, a cable stop 216 on the cable keeps the cable 214 from slipping through the recess 246. On the side of the housing 211 opposite the projections 242 and 244, the cable is guided along the housing 211 and leads to the belt buckle or to webbing connected to the cable 214.

A hollow cylinder 282 is arranged between the guiding portions 228 inside the housing 211. The cylinder 282 accommodates a gas generator 276 rigidly connected to the cylinder 282 and a piston 252 slidably guided inside the cylinder 282. The piston 252 has a tip 248 protruding from the end of the cylinder 282 pointing toward the face 258 of the slide 224. The gas generator 276 occupies an axial portion of the cylinder 282 at an end of the cylinder 282 opposite the face 258. The gas generator 276 has electric contacts 278 leading outside the housing 211 and configured to be connected to an electronic control unit (not shown) for deploying the gas generator 276.

FIG. 7 shows a first variation of the cylinder 282 and the piston 252 of the embodiment of FIG. 6. The cylinder 282 has a conically tapered end portion 286 with a central opening 292. The piston 252 is press-fitted into the opening 292 and has a smooth cylindrical surface extending from the tip 248 to the gas generator 276. The piston 252 is designed as a hollow piston. Due to press-fitting the piston 252 into the opening 292, a pressure-actuated ballistic seal is established between the cylinder 282 and the piston 252, providing for the above-described restart capability. When the gas generator 276 is deployed, the gas pressure inside the cylinder 282 rises, and the piston 252 is pushed outward. The tip 248 abuts the actuating profile 256 of the slide 224 and pushes it in the outward direction away from the gas generator 276. Because the slide 224 has the guiding portions 228 aligning the side 224 in the housing 211, the slide 224 and the piston 252 need not be rigidly connected to each other for proper alignment.

The cable 214 extends along both sides of the housing and is fastened to the housing at the projections 242 and 244. Thus, a movement of the slide 224 pulls the cable 214 by twice the distance of the movement. The cable 214, in turn, tightens the attached belt webbing or retracts a belt buckle along with an inserted latch plate attached to a seat belt.

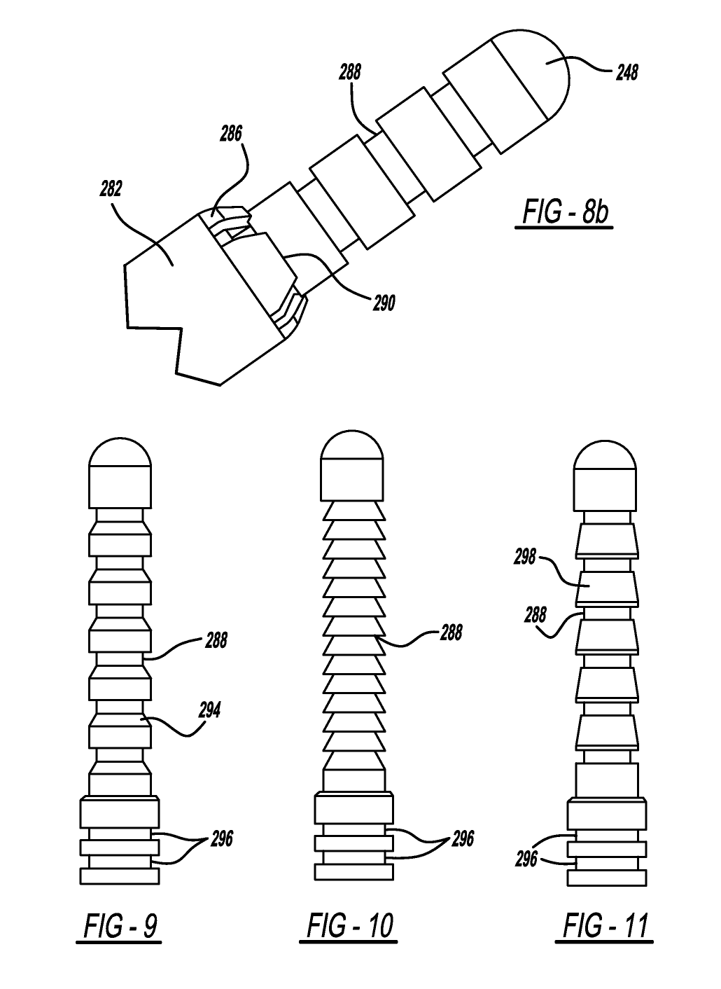

FIGS. 8a and 8b show an alternative cylinder-piston arrangement for the third embodiment of the pretensioner device 210 of FIG. 6. The end portion 286 of the cylinder 282 forms tabs 290 bent radially inward. A seal between piston 252 and the cylinder 282 is provided by one or more O-rings (not shown) seated on the circumference of the piston 252 inside the cylinder 282 near the end of the piston 252 that faces the gas generator 276. FIG. 8a shows the normal position of the piston 252 inside the cylinder 282. The tip 248 protrudes beyond the tabs 290, but most of the piston 252 is inside the cylinder 282.

FIG. 8b shows the same cylinder-piston arrangement after deployment. The gas pressure built up by the gas generator 276 has pushed the piston partially out of the cylinder 282. The piston 252 features circumferential grooves 288 adapted to cooperate with the tabs 290. The tabs 290 snap into one of the grooves 288 and prevent the piston 252 from sliding back into the cylinder 282. The tabs 290 are tapered inward in a way that allows the piston 252 to slide out of the cylinder 282, but not into the cylinder 282.

Because the piston 252 is sealed against the cylinder 282 so that the gas pressure inside the cylinder is retained, the piston 252 has the restart capability configured to remove slack in a webbing in several consecutive steps.

As FIGS. 9, 10, and 11 illustrate, the grooves 288 in the piston 252 are not limited to a rectangular profile as shown in FIG. 8b. Because FIGS. 9-11 show only the piston 252, additional circumferential grooves 296 are visible that are configured to receive two of the O-rings (not shown).

FIG. 9 shows grooves 288 with a tapered wall 294 adapted to the shape of the tabs 290. FIG. 10 provides a so-called Christmas tree configuration that allows for smaller distances between adjacent grooves 288 because the grooves are wedge-shaped without any surfaces extending in the axial direction. FIG. 11 shows a piston profile in which not the grooves 288 themselves, but portions 298 between the grooves 288 are tapered to promote that the piston 252 slides smoothly out of the cylinder 282. The shape of the piston 252 is not limited to the profiles shown in FIGS. 7-11. Many variations are conceivable that may combine the features of FIGS. 7-11 or add new properties.

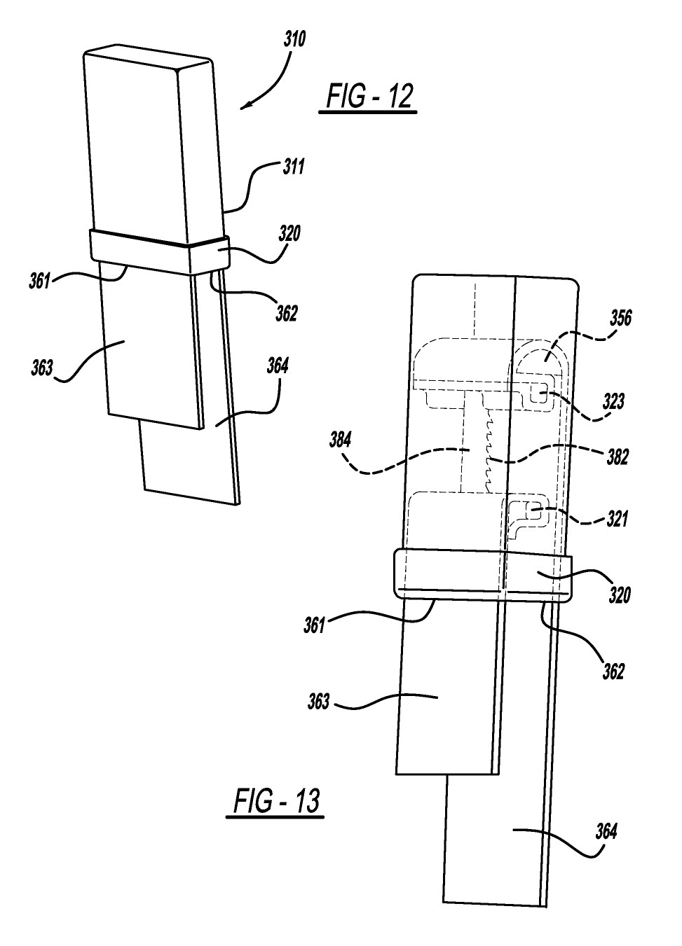

FIGS. 12 through 16 show a fourth embodiment of a PLP configured as a triple-stroke pretensioner device 310 with a housing 311 and a lid 320. The dimensions of pretensioner device 310 are remarkably small compared to known pretensioner devices. Hence, the pretensioner device 310 is also referred to as micro-PLP.

Housing 311 measures approximately 6 cm×7 cm×1.5 cm. These small dimensions are made possible because the pretensioner device 310 is capable of shortening a seat belt by a length corresponding to triple the distance of the piston stroke. In this embodiment, the pretensioner device 310 exerts tension on two ends of belt webbing.

A first segment 364 of belt webbing is threaded through a first slot 362 in the lid 320 and fastened to a movable bar 321 inside the housing 311 as discussed in more detail below. The terms “movable” and “non-movable” in this context relate to movements relative to the housing 311 and the lid 320. A second segment 363 of belt webbing is threaded through a second slot 361 in the base 320 and fastened to a non-movable bar 323 inside the housing 311. When installed in a vehicle, the first segment 364 of belt webbing typically leads to a latch plate of a seat belt, and the second segment 363 of belt webbing leads to an anchor fastened to a vehicle frame part.

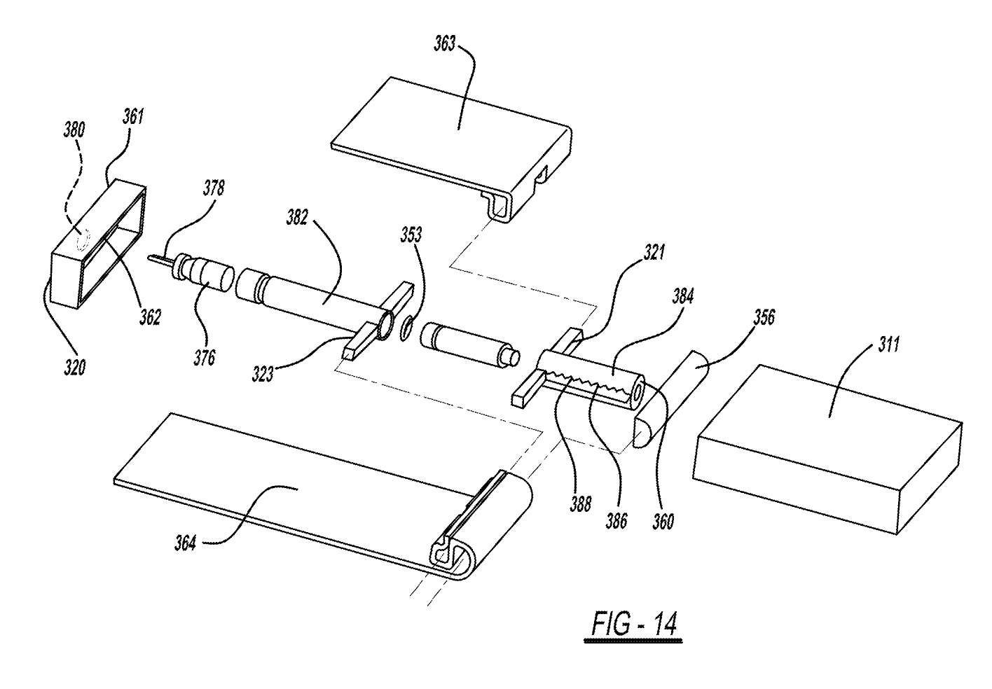

FIG. 13 illustrates the arrangement of the pretensioner device 310 inside the housing 311. For a better understanding of the individual parts inside the housing 311, FIG. 14 shows the same arrangement as FIG. 13, but in an exploded view. Referring now to both FIGS. 13 and 14, it is evident that the first segment 364 of belt webbing enters the housing through slot 362 in the lid 320. Inside the housing 311, the first segment 364 is guided around a pulley 356, makes a U-turn leading back in a direction toward the lid 320, and is fastened to the bar 323. The bar 323 is stationary with respect to the housing 311 and is formed on an open end of a hollow cylinder 382 extending from the bar 323 to the lid 320.

At its end proximate to the lid 320, the hollow cylinder 382 accommodates a gas generator 376 that is crimped into the hollow cylinder 382 so as to be sealed off against the outside of the hollow cylinder 382. The gas generator 376 is configured to be triggered through an electrical line 378 that is threaded through a hole 380 in the lid 320 to the outside for a connection to an electronic control unit (not shown).

The hollow cylinder 382 also contains a piston 352 inserted from the open end near the bar 323. The piston 352 is equipped with an annular seal 353 around its circumference that seals the piston 352 slidably in the hollow cylinder 382 sufficiently to ensure the restart capability described above. A combustion pressure generated upon deployment of the gas generator 376 propels the piston 352 away from the gas generator. The piston 352 abuts the pulley 356 and drives it away from the gas generator 376. Because the end of the first segment 364 of the belt webbing is fastened to the stationary bar 323, the first segment 364 is pulled into the housing 311 by twice the distance that the pulley 356 travels.

In the shown embodiment the seal 353 is shown as an O-ring. It is, however, within the scope of the present invention to effect a seal by other means, for instance by providing a hollow piston 352 that establishes a ballistic seal with the inside walls of the hollow cylinder 382 when the gas generator 376 increases the gas pressure inside the hollow cylinder 382.

The second segment 363 of belt webbing is inserted into the housing 311 through slot 361 and fastened to the movable bar 321 that is formed on a slotted sleeve 384. The slotted sleeve 384 extends from the bar 321 to the pulley 356. The sleeve 384 has an abutment shoulder 360 for the piston 352. Accordingly, the piston, once propelled by the gas generator 376, moves the sleeve 384 by the same distance as the pulley 356. The sleeve 384 has two opposite slots 386 extending in axial direction of the sleeve 384.

At least one of the slots 386 has ratchet teeth 388 along an edge extending in the axial direction. The ratchet teeth 388 cooperate with a protrusion 390 formed on the hollow cylinder 382 adjacent to the stationary bar 323. This detail is shown in an enlarged view in FIG. 16. The ratchet teeth 388 engage the protrusion 390 and lock the sleeve 384 in an extended position after the gas generator 376 has pushed the piston 376, the sleeve 384, and the pulley 356 away from the lid 320. Because the second segment 363 of webbing is fastened to the bar 321 on the slotted sleeve 384, the second segment 363 is pulled into the housing 311 by a distance that is the same as the distance traveled by the piston 352.

FIG. 14 illustrates how the gas generator 376 and the piston 352 are arranged inside the hollow cylinder 382, which in turn is accommodated inside the slotted sleeve 384. The bar 323 of the hollow cylinder 382, which does not move relative to the housing 311, penetrates the slots 386 and interacts with the ratchet teeth 388. The bar 321 is formed on the slotted sleeve and moves with the piston 352.

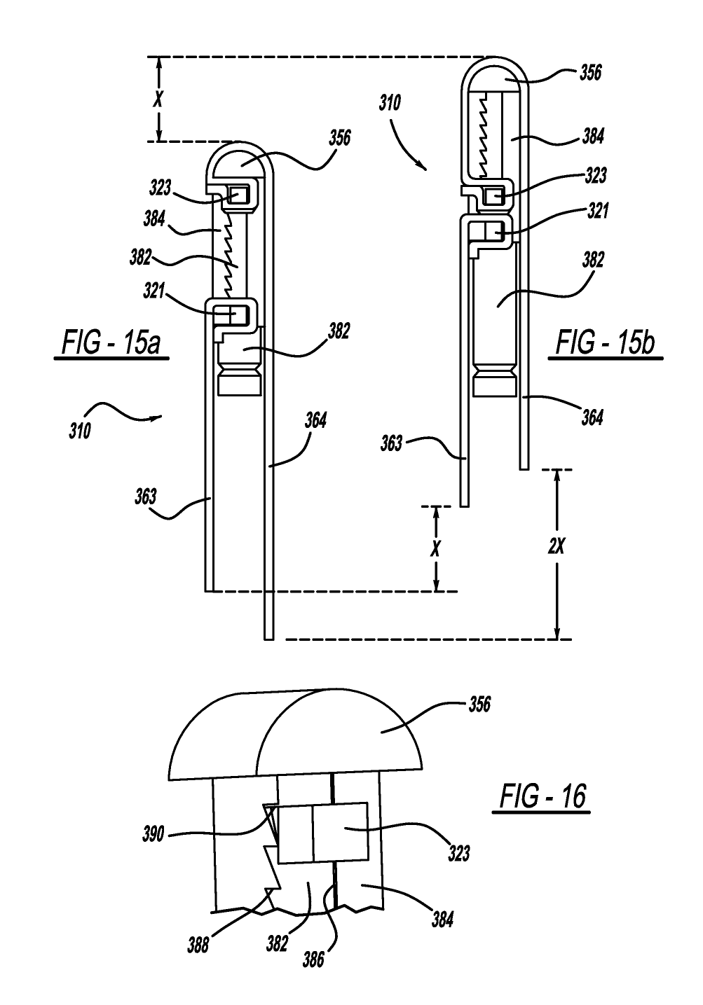

FIG. 15 shows in detail how a movement of the piston 352 away from the lid 320 effects a shortening of the seat belt webbing by three times the distance X, where the distance X corresponds to the piston travel. The shortening of the seat belt is composed of shortening the first segment 364 of webbing by twice the distance X and shortening the second segment 363 of webbing by once the distance X.

FIG. 15a shows the pretensioner device 310 in a default or normal position before the gas generator 376 is triggered. The slotted sleeve 384 covers most of the axial length of the hollow cylinder 382. The stationary bar 323 is located at an end of the slot 386 that is adjacent to the pulley 356.

FIG. 15b shows the pretensioner device 310 after deployment. When the gas generator 376 (not shown) deploys inside the hollow cylinder 382, the piston 352 is pushed out of the hollow cylinder 382 and drives the slotted sleeve along with the pulley 356 upward. While the bar 323 formed on the hollow cylinder 382 remains stationary, the bar 321 formed on the slotted sleeve 384 is moved with the slotted sleeve. The piston 352, the slotted sleeve 384 with the bar 321, and the pulley 356 all move in the same direction by the same distance X.

The bar 321 pulls the second segment 363 of webbing upward by the same distance X. As the pulley 356 moves upward, the bar 323 holds one end of the first segment 364 of belt webbing in place. Accordingly the first segment 364 is shortened, meaning pulled into the housing, by a distance 2X because the first segment 364 of belt webbing is wrapped around the pulley and lines the slotted sleeve from two sides.

From FIG. 16, the configuration of the ratcheted slots 386 in sleeve 384 becomes evident. The ratchet teeth 388 extend along one axial side of the slot 386. On the hollow cylinder 382, adjacent to the stationary bar 323, a protrusion is formed having a shape adapted to the ratchet teeth 388. While an upward movement of the sleeve 384 relative to the hollow cylinder 382 is possible, a reverse movement is blocked by the protrusion 390 engaging the teeth 388.

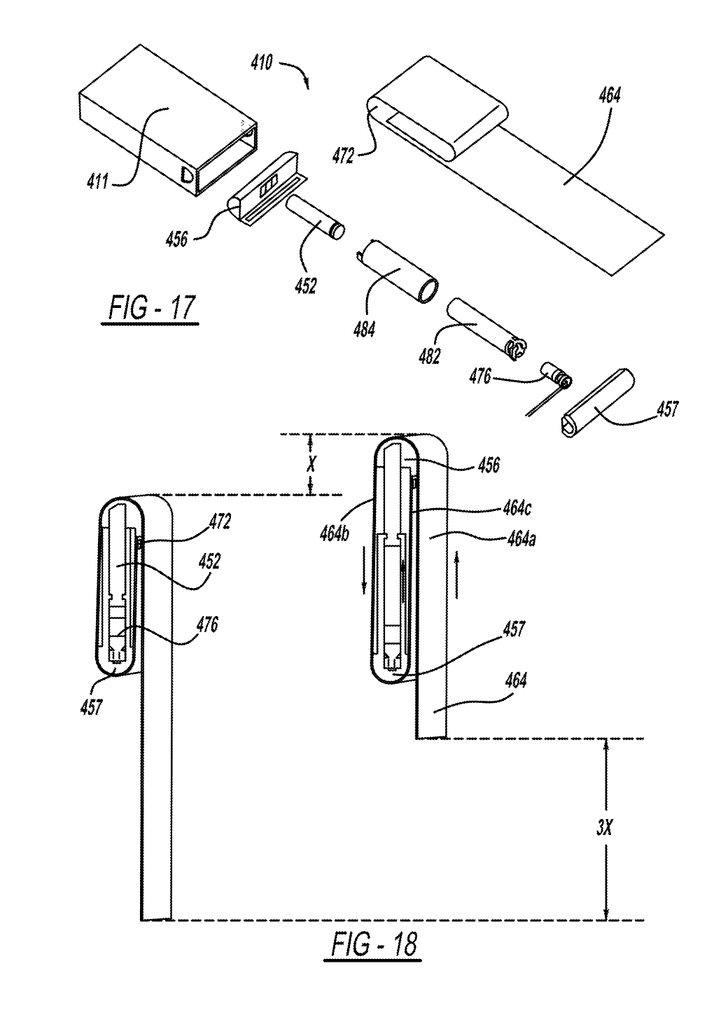

FIGS. 17 and 18 illustrate a fifth embodiment of a pretensioner device 410 configured as an alternative micro-PLP. FIG. 17 shows the elements of the pretensioner device 410 in an exploded view. FIGS. 18a and 18b depict the pretensioner device 410 in the normal default position and in the deployed position, respectively.

The pretensioner device 410 has a housing 411 designed to be mounted on a vehicle part. Only one strap 464 of webbing enters the housing 411. The strap 464 is guided into the housing 411 around a first movable pulley 456 deflecting the strap 464 by 180°. From the first pulley 456, the strap is guided back toward its entry into the housing and led around a second, stationary pulley 457. From the second pulley 457, the strap 464 is guided to the first pulley again and is fastened to a portion of the first pulley 456.

The pretensioner device 410 of FIGS. 17 and 18 is composed of remarkably simple parts. It has a sleeve 484 that, in the shown embodiment does not have ratcheted slots. A hollow cylinder 482, for instance made of steel, accommodating a crimped-in gas generator 476 on one side and a movable piston 452 on the other side is inserted into the sleeve 484. The piston 452 can be sealed in the cylinder 482 with a pressure-activated ballistic seal or with an elastomeric seal as described in connection with the previous embodiments, thereby ensuring the above-described restart capability. It is conceivable to provide ratcheted slots in the sleeve 484 in analogy to the example of FIGS. 12-16. Corresponding noses or protrusions can be formed on the hollow cylinder 482 to cooperate with the ratcheted slots to prevent a retraction of the sleeve 484 after deployment.

FIG. 18b indicates with arrows how the strap 464 is shortened upon deployment of the gas generator 476. The strap 464 is arranged in the housing (not shown in FIG. 18) in a first, second and third portion 464a, 464b, and 464c. The first portion 464a extends from entering the housing to the first pulley 456. The second portion extends from the first pulley 456 to the second pulley 457 and connects the first portion 464a with the third portion 464c. The third portion 464c forms a layer under the first portion 464c and extends from the second pulley 457 to the first pulley 456. The third portion 464c is fastened at its end 472 to the first pulley 456.

As mentioned before, the second pulley 457 is stationary. In contrast, the first pulley 456 is moved away from the first pulley when the combustion pressure generated by the gas generator 476 propels the piston 452 in a direction away from the gas generator 476. The distance between the first and the second pulley 456 and 457 increases by the distance X of the piston stroke. Due to the increased distance, the first, second, and third portions 464a, 464b, and 464c of the strap 464 each increase in length by the same distance X. Because each of the three portions 464a, 464b, and 464c takes up its additional length from the strap 464, the strap 464 is pulled into the housing by a distance of 3X.

While all the exemplary embodiments exhibit different details, combinations of these details are not limited to those shown within the same embodiment. For instance, the various ratchet configurations are interchangeable with minor modifications that are within the abilities of a person of ordinary skill in the art.

Also, for reducing friction during the operation of the various embodiments of the present invention, any of the shown actuating profiles or slot radii may optionally be equipped with rollers or coating without leaving the scope of the present invention.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. Such modifications include combinations of details disclosed in different embodiments. All such modifications and variations are within the scope of the invention as determined by the appended claims when interpreted in accordance with the breadth to which they are fairly, legally, and equitably entitled.

1. A linear pretensioner for use as part of a motor vehicle occupant belt restraint system of the type mountable to a motor vehicle structure and coupled with a belt restraint system component, the pretensioner, upon being activated, pulling the belt restraint system component to pretension the belt restraint system, the linear pretensioner comprising:
a housing with a base configured to be anchored to a vehicle and an enclosure attached to the base, the enclosure defining an axial cavity elongated in an axial direction;
an actuating profile configured to be axially moved by the piston and arranged at least partially outside the axial cavity;
a guide arrangement configured to receive a section of flexible material contributing to a seat belt length, the section of flexible material being guided with respect to the housing in a manner that the flexible material crosses the axial path of the actuating profile;
an axially expandable combustion chamber in the elongated cavity arranged between the base and the actuating profile and operatively connected to the actuating profile to axially displace the actuating profile from the retracted state to the expanded state, the combustion chamber being sealed so as to retain gas pressure; and
a pyrotechnical gas generator in communication with the combustion chamber, the gas generator being configured to be deployed in an emergency situation and to generate a gas pressure in the combustion chamber sufficient to axially expand the combustion chamber and to cause an axial displacement of the actuating profile and the section of flexible material received in the guide arrangement, the combustion chamber being sufficiently sealed to cause a subsequent partial axial displacement of the actuating profile after a first partial axial displacement.

2. The pretensioner of claim 1, wherein the axial cavity has an open end and a closed end, the combustion chamber being formed by a piston movably arranged in the axial cavity in a manner providing a seal between the piston and the axial cavity, the piston being slidable along an axial path to at least partially emerge from the axial cavity at the open end.

3. The pretensioner of claim 2, further comprising that the piston is a hollow piston configured to form a ballistic seal with the axial cavity upon deployment of the gas generator.

4. The pretensioner of claim 1, the housing further comprising a recess accommodating the pyrotechnical gas generator, the recess being in open communication with the combustion chamber and having a channel connecting the recess with an area outside the housing, with an electrical conductor leading from the pyrotechnical device through the channel to the outside area, the channel being sealed off around the conductor thereby sealingly separating the recess from the outside area.

5. The pretensioner device of claim 1 wherein the combustion chamber is confined by a deformable bladder element and the base, the bladder element having a normal, deflated state forming the normal state and being configured to axially expand in the axial direction when a gas pressure in the combustion chamber exceeds atmospheric pressure.

6. The pretensioner of claim 5, further comprising that the bladder element is a rolling sock which in the normal state comprises an inner wall arranged inside an outer wall, the outer and inner walls extending over an axial distance and being integrally connected at an axial end facing the displacement space, the outer wall having an outward flange at an end facing the base, the flange being sealingly connected to the base, and the inner wall having a bottom at an end facing the base, the inner wall and the bottom forming a pot-like structure.

7. The pretensioner of claim 6, further comprising that the rolling sock is configured to roll the inner wall outward and moving the bottom toward the displacement space when exposed to pressure in the combustion chamber exceeding atmospheric pressure.

8. The pretensioner of claim 5, further comprising a piston arranged between the deformable bladder element and the displacement space, the piston configured to move in the axial direction into the displacement space upon expansion of the deformable bladder element.

9. The pretensioner of claim 8, further comprising that the piston has a shaft and an actuation profile with a rounded face facing the displacement compartment, the shaft being surrounded by a portion of the rolling sock, and the face being adapted to displace a length of seat belt webbing into the displacement space.

10. A linear pretensioner for use as part of a motor vehicle occupant belt restraint system of the type mountable to a motor vehicle structure and coupled with a belt restraint system component, the pretensioner, upon being activated, pulling the belt restraint system component to pretension the belt restraint system, the linear pretensioner comprising:
a housing with a base configured to be anchored to a vehicle and an enclosure attached to the base, the enclosure defining a cavity elongated in an axial direction;
a pair of radially opposing slots in the enclosure configured to receive a seat belt webbing to be threaded through the slots across the elongated cavity, thereby dividing the elongated cavity into an expansion space remote from the base and a displacement space proximate to the base;
an actuating profile arranged in the displacement space configured to move axially in the elongated cavity having a normal, retracted state and an expanded state in which the actuating profile abuts the seat belt webbing and axially displaces the seat belt webbing between the slots so as to lengthen the seat belt webbing received between the slots;
an axially expandable combustion chamber in the elongated cavity arranged between the base and the actuating profile and operatively connected to the actuating profile to axially displace the actuating profile from the retracted state to the expanded state.

11. The pretensioner of claim 9, further comprising that the seat belt webbing extends between the slots in a substantially straight line while the actuating profile is in the normal state.

12. The pretensioner of claim 9, the enclosure further comprising radii bordering the slots, the radii being formed on edges making contact with the belt webbing.

13. A linear pretensioner for use as part of a motor vehicle seat belt restraint system of the type mountable to a motor vehicle structure and acting on a seat belt, the pretensioner upon being activated, pretensioning the seat belt to reduce slack in the seat belt, the linear pretensioner comprising:
a housing with an axial cavity having a closed end and an open end;
a gas generator in communication with the axial cavity and configured to pressurize the axial cavity;
a piston movably arranged in the axial cavity in a manner providing a seal between the piston and the axial cavity, the piston being slidable along an axial path to at least partially emerge from the axial cavity at the open end;
an actuating profile configured to be axially moved by the piston and arranged at least partially outside the axial cavity;
a guide arrangement configured to receive a section of flexible material contributing to a seat belt length, the section of flexible material being guided with respect to the housing in a manner that the flexible material crosses the axial path of the actuating profile; and
a ratchet-type arrangement permitting a movement of the piston outward from the open end of the axial cavity and withstanding a movement of the piston in the reverse direction.
the actuating profile being configured to abut the flexible material in the guide arrangement and, when moved by the piston, to axially move the flexible material within the guide arrangement relative to the guide arrangement so as to pull additional flexible material from outside the guide arrangement into the guide arrangement.

14. The pretensioner of claim 13, further comprising a ratchet arrangement with a first ratchet element formed on the axial cavity and a second ratchet element formed on a part movable with the piston, the ratchet arrangement counteracting a movement of the piston toward the first end of the axial cavity.

15. The pretensioner of claim 13, wherein a piston travel along the axial path by a specified distance lengthens the length of the flexible material received by the guide arrangement by approximately twice the specified distance.

16. The pretensioner of claim 12, wherein the first ratchet element is an array of ribs or teeth and the second ratchet element is a plurality of tabs formed on the piston configured to snap into the ribs or teeth.

17. The pretensioner of claim 12, wherein the first ratchet element is a plurality of inward tabs formed on the second end of the axial cavity and the second ratchet element is an array of radial annular grooves in the piston.

18. The pretensioner of claim 12, wherein the first ratchet element is a protrusion formed on a cylinder forming the cavity and the second ratchet element is an array of teeth formed on a sleeve surrounding the cylinder and movable with the piston.

19. The pretensioner of claim 11, wherein the axial cavity is formed by a cylinder inserted into the housing.

20. The pretensioner of claim 19, wherein the cylinder is made of metal.

21. The pretensioner of claim 11, wherein the actuating profile is a separate part contacting the piston.

22. The pretensioner of claim 21, wherein the actuating profile is affixed to the piston.

23. The pretensioner of claim 11, wherein in the guide arrangement is formed by two opposite slots in the housing and the section of flexible material is a portion of seat belt webbing.

24. The pretensioner of claim 11, wherein the section of flexible material is a cable attached to a seat belt webbing and the guide arrangement is formed by elements guiding the cable around the actuating profile.

25. The pretensioner of claim 12, wherein the section of flexible material is a first segment of seat belt webbing having an end secured to a part that is stationary with respect to the housing, further comprising a second segment of seat belt webbing secured to a part movable with the piston and guided with respect to the housing.

26. The pretensioner of claim 25, wherein a piston travel by a distance along the axial path pulls the second segment of seat belt webbing into the housing by a distance equal to the distance of the piston travel.

27. A linear pretensioner for use as part of a motor vehicle seat belt restraint system of the type mountable to a motor vehicle structure and acting on a seat belt, the pretensioner upon being activated, pretensioning the seat belt to reduce slack in the seat belt, the linear pretensioner comprising:
a housing with an axial cavity, the axial cavity having one closed end and one open end;
a gas generator communicating with the axial cavity and configured to pressurize the axial cavity;
a piston movably arranged in the axial cavity in a manner providing a seal between the piston and the axial cavity, the piston being slidable along an axial path to at least partially emerge from the axial cavity at the open end thereof, the piston being configured to be moved along the axial path by gas pressure caused by a deployment of the gas generator;
a first actuating profile movable with the piston along the axial path and arranged at least partially outside the axial cavity;
a second actuating profile arranged stationary with respect to the housing;
seat belt webbing with an end connected to a fastening element movable with the piston, a first section of the seat belt webbing extending from the fastening element to the second actuating profile, a second section of the seat belt webbing connected to the first section and extending from the second actuating profile to the first actuating profile, a third section of the seat belt webbing connected to the second section and extending from the first actuating profile to the second actuating profile, the seat belt webbing extending from the third section toward further elements of a seat belt arrangement;
the first actuating profile being configured to expand the distance between the first actuating profile and the second actuating profile by a specified distance when the piston moves along the axial path by the specified distance, thereby lengthening each of the first, second, and third sections of the belt webbing by pulling a length of approximately three times the specified distance of the seat belt webbing from the further elements of the seat belt arrangement.

28. The pretensioner of claim 27, wherein the axial cavity is formed by a cylinder inserted into the housing.

29. The pretensioner of claim 28, wherein the cylinder is made of metal.

30. The pretensioner of claim 27, wherein the first actuating profile is a separate part contacting the piston.

31. The pretensioner of claim 30, wherein the first actuating profile is affixed to the piston.
